(19) United States
(12) Patent Application Publication
(10) Pub. No.: US 2011/0184805 A1
(43) Pub. Date: Jul. 28, 2011

(54) SYSTEM AND METHOD FOR PRECISION PLACEMENT OF IN-GAME DYNAMIC ADVERTISING IN COMPUTER GAMES

(75) Inventors: Eyal Margalit, Rehut (IL); Nir Hagshury, Tel Aviv (IL)

(73) Assignee: TICTACTI LTD., Tel Aviv (IL)

(21) Appl. No.: 13/120,883

(22) PCT Filed: Sep. 29, 2009
(86) PCT No.: PCT/IL09/00928

§ 371 Date: Mar. 24, 2011

Related U.S. Application Data
(60) Provisional application No. 61/099,914, filed on Sep. 25, 2008.

(51) Int. Cl. G06Q 30/00

(52) U.S. Cl. 705/14.49

(57) ABSTRACT

The present invention provides a system for precision in-game dynamic advert placement in computer games, comprising: a. networked game playing means; b. at least one game, stored in at least one game domain; c. means for obtaining at least one real-time AV caption of the output generated by said computer game; d. identifying means, having access to said at least one AV output of said at least one computer game; e. means for superimposing at least one remotely stored advertising content onto the entirety of caption, or onto parts thereof; wrapper means, located at said game domain, wrapping said game; f. means for customizing ads to be downloaded by said wrapper. Said ad customizing means synchronizes the audio-visual display generated by said game with said superimposed advertising content, and controls the insertion and removal of said advertising content, thereby offering a distortion-free viewing experience.

### FIELD OF THE INVENTION

The present invention generally pertains to a system and method for precession placement of in-game dynamic advertising in computer games.

### BACKGROUND OF THE INVENTION

In-game advertising (IGA) refers to the use of computer and video games as a medium in which to deliver advertising. Advertisers see IGA as a prime way to target the male 18-34 demographic, who are increasingly neglecting television in favour of computer and video games.

### Static In-Game Advertising

Early examples of in-game advertising were static. Some of these consisted of virtual billboards, whereas others could be considered in-game product placement. These advertisements were placed directly into the game by artists or programmers and could not be changed later. The first example was seen in the 1978 computer game Adventureland by Scott Adams, who inserted an advertisement for his then forthcoming game Pirate Adventure. Examples of in-game advertising of third party products include the sponsorship of the Zool series by Chupa Chups, leading to various displays of the Chupa Chups product and brand in the game, including a series of levels set in a Sweet world. Another early example of in-game advertising can be seen in the FIFA International Soccer series, with commercial billboard advertisements featured in-game since 1994. Static advertisements allow the advertiser and developers to have more influence on how the advertisements are displayed in-game and can be worked to beyond the levels of a pure billboard. In Splinter Cell: Chaos Theory for example, a large glowing advertisement for AXE deodorant appears hard coded in the game, forming an obstacle to the player character. Not only did it allow the developers to experiment with dramatic lighting effects, it also drew the players' attention by providing them with a challenge to overcome. Chupa Chups products can be seen in the background of the 1992 computer game Zool.

An Adidas billboard is displayed in the foreground of the 1994 computer game FIFA International Soccer (also, the electronic board that appears with every goal scored sometimes reads “Panasonic”).

### Dynamic In-Game Advertising

Similar to how a websites rotate different ads through the same fixed space, dynamic in-game advertising can change the messaging on the same billboard in a game. This requires billboard space insertion into the game, as well as a broadband-connected gaming system to work. An example can be found in a poster campaign for Tripping the Rift inserted in the 2005 computer game SWAT 4.

Increasing Internet connectivity has led to the growth of dynamic in-game advertising. Unlike the fixed advertisements found in static in-game ads, dynamic advertisements can be altered remotely by the advertising agency. Advertisements can be tailored according to geographical location or time of day, allowing for the delivery of time-critical advertising campaigns, such as those publicizing a movie launch. Information can be sent back from the player's machine regarding advertisement performance; data such as time spent looking at advertisements, type of advertisement and viewing angle may be used to better formulate future campaigns and also allows the advertising agency to offer more flexible advertising campaigns to their clients. American video game publisher, THQ, commented in an interview that data collected from in-game advertising had an unexpected benefit as a design tool, “If the character is stuck in front of a brick wall with an ad poster on it, we know that the level might be too hard. We now see the ad-tracking system as a way to find ways to improve on a game's design”. Because dynamic advertising campaigns do not have to be hard-coded into the game by artists and programmers, the need for advertisers to formulate and insert campaigns months in advance of a games launch is negated.

Examples of dynamic in-game advertising include the 2005 computer game SWAT 4 by Irrational Games. Version 1.1 of the game featured dynamic in-game advertisements delivered by Massive Incorporated, these advertisements were used to publicize forthcoming television shows targeted at a US audience. These time and location sensitive advertisements would not have been effective if delivered through a static in-game advertising campaign. In October 2008, billboard ads featuring then US Democratic Presidential candidate Barack Obama appeared in the game Burnout Paradise, which was first released in January. Electronic Arts, the game's publisher confirmed that the Obama campaign paid for the advertisements, marking the first time that a US presidential candidate has bought in-game advertising.

Traditionally, not all games were thought suitable for in-game ad placement, due to difficulties in detecting the time and place of games' story line.

US 20060053048 discloses a method for improving upon the conventional pop-up ad, by introducing flexibility with regard to the shape of the advert and its placement in the surroundings of a web browser. Thus US 20060053048 addresses the shortcomings of standard rectangular adverts that often obscured the content they were presented in conjunction with. However, US 20060053048 discloses advert insertion that is not context dependent and does not present the possibility of dynamically controlling ads, as well as interacting with them.

US patent application 20060128470 discloses a method for consolidating dynamic in-game advertising by grouping video games with similar demographic characteristics into an aggregated community of advertising spots; and, delivering the same advertising content for display within each of the advertising spots within the aggregated community of advertising spots. However, it requires the ad hot-spots that receive the feed of ads to be written into each game's code.

US patent application 20030028873 discloses a method and system in which “labels,” comprising supplemental information such as advertising, promotional, or informational elements including interactive elements, may be superimposed post-production into a video stream. This is achieved by using overlay screens including interactive overlay screens or by combining content video and supplementary signals. As such, the labels do not have to physically be part of the actual scene during filming. Once a video stream is created, a space for available advertising is designated either manually or automatically by pattern recognition techniques. A list of available advertising space is generated. During viewing of television broadcasts, advertisements are placed in the video signal. Labels are displayed by superimposing an HTML page that is blank except for the advertisement onto the video signal. Advertisements can be superimposed post-production, and can be personalized and localized. The advertisements can be customized on a per-household basis.

However, while US patent application 20030028873 offers context dependent placement of ads in strategically identified predetermined locations along the timeline of the media, the ‘intelligent’ placement, and more particularly the context that triggers the insertion of the ad and its subsequent removal, is predetermined both in terms of the physical location and the duration of its appearance. Thus while US patent application 20030028873 offers contextual ad placement, it is limited to media with a single set timeline, such as a conventional prerecorded films. Presented with dynamic user dependent content, for example a computer game or a live news feed, US patent application 20030028873 does not offer real-time context dependent means for controlling the timely insertion and removal of the overlay ad layer. Moreover, conventional means for visually identifying and tracking content, continually scan the content thereby placing substantial strain on computer processing power. Furthermore, the technology of choice for a ‘clickable’ overlay layer in US patent application 20030028873, namely HTML, severely limits its application. For example it prevents full screen presentation and is so cumbersome to execute in an interactive media, such as a visually dynamic computer game, that it is virtually inapplicable. Moreover, US patent application 20030028873 does not provide efficient means and method for performing a heavy task of superimposing ads and removing them within the time frame of milliseconds. Furthermore, by relying on HTML technology, in US patent application 20030028873 detecting user input may cause distortions to the view and to the user interface of the content. Furthermore, US patent application 20030028873 does not provide means and method for taking into account random or user defined themes in real time.

It is therefore a well felt need to provide an interactive a precision in-game dynamic ad placement system and method that does not require ad hot-spots to be programmed into the game code. It is a further long felt need that said system an method are not restricted to insertion in games that do not take advantage of the entire screen space. It yet another well felt need to provide a method for tracking elements or objects within audio -visual content that does not require constant uninterrupted monitoring and analysis of the content stream. It is a further long felt need that the placement of the ads is not hampered by and does not interfere with the dynamic interactive nature of the gaming experience. It is a further long felt need that said ads are not limited to predetermined ‘electronic billboards’. It is a further long felt need that said ads do not interfere with the sequence of the game. It is yet another long felt need that said system and method no be restricted by the shortcomings of the use of HTML technology to overlay the game. It is yet another object of the present invention to overcome the technological incompatibility between legacy ad servers that are tailored for html presentation, and the demands of flash presentation. It is yet another object of the present invention to overcome security difficulties that arise from attempting to customize presentation of ads using content stored at several different domains.

### SUMMARY OF THE INVENTION

It is an object of the present invention to disclose a system for precision in-game dynamic advert placement in computer games, comprising: networked game playing means; having access to, at least one game, stored in at least one game domain; means for obtaining at least one real-time AV caption of the output generated by said computer game; means for identifying objects, AV events, or a combinations thereof, having access to said at least one AV output of said at least one computer game; means for superimposing at least one remotely stored advertising content onto the entirety of said at least one caption, or, onto parts thereof; wrapper means, located at said game domain, wrapping said game; and, means for customizing ads to be downloaded by said wrapper to the location of said game playing means; wherein said ad customizing means, synchronizes the audio-visual display generated by said game with said superimposed advertising content, and controls, within a precession of milliseconds, the insertion and removal of said advertising content, thereby offering a distortion-free viewing experience.

It is within the scope of the present invention that the ad placement system, additionally comprises emulation means that superimposes at least one invisible emulation layer, which is click, touch or event enabled, on top of said visual output generated by said computer game; wherein said superimposed emulation layer, mediated by said ad customizing means, communicates instructions to said game playing means, said means for superimposing ad content, or a combination thereof, such that insertion and removal of ad content corresponds to the dynamic real-time progression of said game, as well as real time user actions.

It is within the scope of the present invention that ad placement system additionally comprises object tracking means adapted for locating and tracking said identified objects or events.

It is within the scope of the present invention that said game is stored locally, remotely, or a combination thereof.

It is within the scope of the present invention that the format of said advertising content is selected from a group consisting of flash, animation, Html, script, images, video, hyperlink, music, vocals, or a combination thereof.

It is within the scope of the present invention that the physical characteristics of said advertising content is selected from a group consisting of transparent, semi-transparent, opaque, still, animation, or a combination thereof.

It is within the scope of the present invention that said advertising content is selected from a group consisting of promotions, vouchers, rebates, virtual prizes, physical prizes, or a combination thereof.

It is within the scope of the present invention that the ad placement system, additionally comprises an audio processing and analysis means.

It is within the scope of the present invention that the ad placement system that said game is compiled in a format selected from a group consisting of flash, video stream, shockwave, java applet, C++, C#, Viusal Basic, Java, ActiveX, Adobe AIR Application, Widget, Gadget, Microsoft Silverlight, DotNet framework based language, or a combination thereof.

It is within the scope of the present invention that the ad placement system additionally comprises a remote database for logging said instructions.

It is within the scope of the present invention that the ad placement system additionally comprises means for toggling between visible and invisible modes of said superimposed advertising content.

It is within the scope of the present invention that the ad placement system, additionally comprises means for storing data obtained from said object identification means.

It is within the scope of the present invention that the ad placement system, additionally comprises a real-time synchronization means for interrupting or cancelling said stream of superimposed advertising content in response to data obtained from said object tracking means.

It is within the scope of the present invention that the ad placement system, additionally comprises a display means interconnected to said playing means.

It is within the scope of the present invention that said object identification means is selected from a group consisting of a human observer, and automated observer, or a combination thereof.

It is within the scope of the present invention that said objects are selected from a group consisting of backgrounds, players, icons, items, script, images, videos, animation, or a combination thereof.

It is within the scope of the present invention that said networked connection is selected from a group consisting of wired, Wireless, or a combination thereof.

It is within the scope of the present invention that said wireless communication means is selected from a group consisting of: WIFI, WIMAX, cellular, satellite, RFID, or a combination thereof.

It is within the scope of the present invention that said game playing means additionally comprises a GPS location identification means.

It is within the scope of the present invention that said game playing means additionally comprises a unique identification code.

It is within the scope of the present invention that said system additionally comprises image analysing means for analysing the visual characteristics of said objects and the area surrounding them.

It is within the scope of the present invention that said system additionally comprises object recognition processing means.

It is within the scope of the present invention that said emulation layer additionally comprises predefined trigger-zones wherein user input, AV events, or a combination thereof trigger instructions to said ad superimposing means, said game playing means or a combination thereof.

It is within the scope of the present invention that said system additionally comprises event or User action activated sampling means.

It is yet another object of the present invention to disclose a method for precision in-game dynamic advert placement in computer games, comprising the steps of: obtaining a system for precision in-game dynamic advert placement in computer games, comprising: networked game playing means; having access to, at least one game, stored in at least one game domain; means for obtaining at least one real-time AV caption of the output generated by said computer game; means for identifying objects, AV events, or a combinations thereof, having access to said at least one AV output of said at least one computer game; means for superimposing at least one remotely stored advertising content onto the entirety of said at least one caption, or onto parts thereof; wrapper means, located at said game domain, wrapping said game; and, means for customizing ads to be downloaded by said wrapper to the location of said game playing means; identifying at least one object, zone, or event within said computer game output by said object identification means; initiating said game by user; downloading said wrapper means to the location of said game playing means; initiating said wrapper means; downloading said ad customizing means to location of said game playing means; initiating said ad customizing means; requesting a real time AV Caption by said ad customizing Means from said wrapper means; validating the security protocol of said customizing means by said wrapper means; capturing a real time AV caption by the wrapper; delivering said caption to said ad customizing means; searching said audio-visual caption for said identified objects or events; locating said identified at least one object, zone, or event in said visual caption; downloading said remotely stored advertising content; synchronizing the insertion and removal of said advertising content with audio visual content generated by said game; superimposing, within millisecond precision, said advertising content upon said identified at least one object, zone, or event in said real-time bitmap frame; repeating said capturing, searching, locating, synchronizing and superimposing steps at intervals until said objects or events are no longer detected, or until a predetermined time has lapsed; and, displaying said game generated bitmap frame without intervention of said superimposed ad content; wherein said step of synchronizing, within a precession of milliseconds, the insertion and removal of said advertising content, enables distortion-free in-game dynamic advertising.

It is within the scope of the present invention that said capturing step comprises sampling a limited segment of the full visual frame.

It is within the scope of the present invention that said limited segment is selected from a group consisting of: virtual buttons, virtual items, virtual objects, text, icons, animation, or a combination thereof.

It is within the scope of the present invention that said method additionally comprises a step of tracking said at least one objet, zone, or event.

It is within the scope of the present invention that the instigation and duration of said tracking step is determined by user actions or computer game events captured by said emulation layer.

It is within the scope of the present invention that said tracking step is executed by sampling a segment of said content video frame.

It is within the scope of the present invention that said method additionally comprises a step of interrupting said streaming step, on object movement data obtained from said step of tracking said objects.

It is within the scope of the present invention that said interrupting step is selected from a group consisting of cancelling, fading out, shifting transparency rate, or a combination thereof.

It is within the scope of the present invention that said interrupting step is instigated by an additional step of interfacing with the user of said game playing means.

It is within the scope of the present invention that said interfacing step is selected from a group consisting of selecting game options, performing game actions, or a combination thereof.

It is within the scope of the present invention that said method additionally comprises a step of detecting, by means of said object tracking means, intervals in the progress, sequence or motion of said game, and subsequently superimposing said advertising content onto said identified objects.

It is within the scope of the present invention that said method additionally comprises the steps of detecting a pause screen within the natural sequence of the play, intercepting the visual progression of the game and superimposing, for a predetermined duration, full screen or partial screen ads onto the display generated by said game, such that said ads mask standard game interval messages selected from a group consisting of pause screens, click to continue screens, user input screens, game over screens, or a combination thereof.

It is within the scope of the present invention that said ads are full screen and are set on a background that emulates the look-and-feel of the standard game screens.

It is within the scope of the present invention that said method additionally comprises the additional step of pacifying the user during the exposure to the ad by display a game loading indication.

It is within the scope of the present invention that said method additionally comprises a step of downloading said game to said networked game playing means.

It is within the scope of the present invention that said method additionally comprises object recognition processing means, said method additionally comprising a step of processing said AV caption and retrieving object recognition data.

It is within the scope of the present invention that said method additionally comprises a step of selecting and contextually matching said selected advertisement content with said object recognition data.

It is within the scope of the present invention that said method additionally comprises a step of toggling between visible and invisible modes of said superimposed advertising content.

It is within the scope of the present invention that said method additionally comprises a step of masking said identified objects by means of superimposing said advertising content onto said identified object, such that said objects are no longer visible.

It is within the scope of the present invention that said method additionally comprises a step of interrupting or cancelling said stream of superimposed advertising content in response to data obtained from said object tracking means.

It is within the scope of the present invention that said method additionally comprises an audio analysis means, said method additionally comprising a step of determining the sequence of superimposing said advertising content according to said analysis.

It is within the scope of the present invention that the display of said computer game output and said superimposed layers is in fullscreen.

It is within the scope of the present invention that setting the frequency of said intervals is determined in a manner selected from a group consisting of: predetermined, determined by user input or computer game events captured by said emulation layer, or a combination thereof.

It is yet another object of the present invention to disclose a method for precision in-game dynamic advert placement in computer games, comprising the steps of: obtaining an ad placement system for superimposing advertising content onto computer games, comprising: networked game playing means; having access to, at least one game, stored in at least one game domain; means for obtaining at least one real-time AV caption of the output generated by said computer game; means for identifying objects, AV events, or a combinations thereof, having access to said at least one AV output of said at least one computer game; means for superimposing at least one remotely stored advertising content onto the entirety of said at least one caption, or onto parts thereof; wrapper means, located at said game domain, wrapping said game; means for customizing ads to be downloaded by said wrapper to the location of said game playing means; and emulation layer superimposing means that superimposes an invisible click, touch or game event enabled control layer on top of said visual output from said computer game, identifying objects within said computer game output by said object identification means; generating said emulation layer containing said identified objects; initiating said game by user; downloading said wrapper means to the location of said game playing means; initiating said wrapper means; downloading said ad customizing means to the location of said game playing means; initiating said ad customizing means; validating the security protocol of said ad customizing means by said wrapper means; superimposing said invisible emulation layer onto output generated by said computer game; capturing a caption of said emulation layer; searching said caption for said identified at least one object, action or event; locating said identified at least one object, zone, or event in said caption; downloading said remotely stored advertising content; synchronizing the insertion and removal of said advertising content with audio visual content generated by said game; superimposing, within millisecond precision, said advertising content; repeating said capturing, searching, locating, synchronizing and superimposing steps at intervals until said objects or events are no longer detected, or until a predetermined time has lapsed; and displaying said game generated bitmap frame without intervention of said superimposed ad content; wherein superimposing said emulation layer upon said game generated outpout, and capturing events and action upon said layer, enables the insertion and removal of ad content that corresponds to the dynamic real-time progression of said game, as well as real time user actions.

It is within the scope of the present invention that said at least one action, or event are selected from a group consisting of swipe, touch, multi-touch, click, mouse over, mouse up, mouse down, drag and drop, real time audio-visual events or a combination thereof.

It is within the scope of the present invention that said capturing step comprises sampling a limited segment of the full video frame.

It is within the scope of the present invention that said limited segment is selected from a group consisting of: virtual buttons, virtual items, virtual objects, text, icons, animation, or a combination thereof.

It is within the scope of the present invention that said method additionally comprises a step of tracking said objects.

It is within the scope of the present invention that the instigation and duration of said tracking objects step is determined by user actions, predetermined time intervals, or computer game events captured by said emulation layer.

It is within the scope of the present invention that said tracking step is executed by sampling a segment of the content video frame.

It is within the scope of the present invention that said method additionally comprises a step of interrupting said streaming step on object movement data obtained from said step of tracking said objects.

It is within the scope of the present invention that said interrupting step is selected from a group consisting of cancelling, fading out, shifting transparency rate, or a combination thereof.

It is within the scope of the present invention that said interrupting step is instigated by an additional step of interfacing with the user of said game playing means.

It is within the scope of the present invention that said interfacing step is selected from a group consisting of selecting game options, performing game actions, or a combination thereof.

It is within the scope of the present invention that said system for superimposing advertising content onto computer games additionally comprising object tracking, additionally comprising a step of detecting, by means of said object tracking means, intervals in the progress, sequence or motion of said game, and subsequently superimposing said advertising content onto said identified objects.

It is within the scope of the present invention that said method additionally comprises a step of downloading said game to said networked game playing means.

It is within the scope of the present invention that said method additionally comprises object recognition processing means, said method additionally comprising a step of processing said AV caption and retrieving object recognition data.

It is within the scope of the present invention that said method additionally comprises a step of selecting and contextually matching said selected advertisement content with said object recognition data.

It is within the scope of the present invention that said method additionally comprises a step of toggling between visible and invisible modes of said superimposed advertising content.

It is within the scope of the present invention that said method additionally comprises a step of masking said identified objects by means of superimposing said advertising content onto said identified object, such that said objects are no longer visible.

It is within the scope of the present invention that said method additionally comprises a step of interrupting or cancelling said stream of superimposed advertising content in response to data obtained from said object tracking means.

It is within the scope of the present invention that said method additionally comprises an audio analysis means, said method additionally comprising a step of determining the sequence of superimposing said advertising content according to said analysis.

It is within the scope of the present invention that the display of said computer game output and said superimposed layers is in fullscreen.

It is within the scope of the present invention that setting the frequency of said intervals is determined in a manner selected from a group consisting of: predetermined, determined by user input or computer game, events captured by said emulation layer, or a combination thereof.

It is within the scope of the present invention that capturing and searching steps are triggered by user actions detected upon said emulation layer, thereby minimizing the time that strain is placed upon computer processing power.

It is within the scope of the present invention that said method additionally comprises the steps of detecting a pause screen with the natural sequence of the play, intercepting the visual progression of the game and superimposing, for a predetermined duration, full screen or partial screen ads onto the game output, such that said ads mask standard game interval messages selected from a group consisting of pause screens, click to continue screens, user input screens, game over screens, or a combination thereof.

It is within the scope of the present invention that said ads are full screen and are set on a background that emulates the look-and-feel of the standard game screens.

It is within the scope of the present invention that said method additionally comprises a step of pacifying the user during the exposure to the ad by display a game loading indication.

It is within the scope of the present invention that said emulation layer masks clickable objects, such that the user cannot click on them for a predetermined time.

It is within the scope of the present invention that both said computer game output is in fullscreen.

It is within the scope of the present invention that said method additionally comprises a step of determining the remote advertising content to be downloaded in step downloading step according to established user data.

It is within the scope of the present invention that said data is selected from a group consisting of demographics data, predetermined groups, registered groups, user input, address, computer playing means, computer playing means system, web browser search log, or a combination thereof.

It is within the scope of the present invention that said ad placement system is adapted for presenting ad content from legacy ad servers, solicited according to user-specific details, is adapted in real-time for presentation in flash based web applications, said system additionally comprising: means for soliciting said legacy ad server content, means for intercepting the presentation of said content; means for analysing said content; means for generating an simulation of said content; and, means for presenting said simulation instead of said content.

It is yet another object of the present invention to disclose an ad placement system, wherein ad content from legacy ad servers, solicited according to user-specific details, is adapted in real-time for presentation in flash based web applications, said system comprising: means for soliciting said legacy ad server content, means for intercepting the presentation of said content; means for analysing said content; means for generating an simulation of said content; and, means for presenting said simulation instead of said content.

It is within the scope of the present that the above mentioned method for ad placement additionally comprises the steps of: obtaining an ad placement system, comprising: means for soliciting legacy ad server content, means for intercepting the presentation of said content; means for analysing said content; means for generating an simulation of said content; and, means for presenting said simulation instead of said content. soliciting at least one legacy ad server content, while identifying to said ad server with user details of the user; sending content by said ad server to said user; intercepting the presentation of said ad content to said user; analysing said content; generating an simulation of said content; and presenting said simulation instead of said content;

It is yet another object of the present invention to disclose a method for ad placement, comprising the steps of: obtaining an ad placement system, comprising: means for soliciting legacy ad server content, means for intercepting the presentation of said content; means for analysing said content; means for generating an simulation of said content; and, means for presenting said simulation instead of said content. soliciting at least one legacy ad server content, while identifying to said ad server with user details of the user; sending content by said ad server to said user; intercepting the presentation of said ad content to said user; analysing said content; generating an simulation of said content; and presenting said simulation instead of said content wherein legacy ad content that was tailored for html presentation is presented in flash compatible format.

It is within the scope of the present invention that said synchronization is bitmap time synchronizing.

### BRIEF DESCRIPTION OF THE FIGURES

In order to better understand the invention and its implementation in practice, a plurality of embodiments will now be described, by way of non-limiting example only, with reference to the accompanying drawings, in which

FIG. 1 illustrates a schematic view of a preferred embodiment of the ad placement method in computer games of the present invention, wherein a processing means, having access to a screen caption of said a real-time game image, locates and tracks the appearance of previously identified bitmap image ‘GET READY’, said processing means instructing remote advertising content stream provider to stream superimposed advertising content onto said real-time game image until said processing means detects that said bitmap image is no longer visible and cancels said superimposed content.

FIG. 2 illustrates a schematic view of a preferred embodiment of the ad placement method in computer games of the present invention, wherein a processing means, having access to a screen caption of said a real-time game image, locates and tracks the appearance of previously identified bitmap image ‘GET READY’, said processing means instructing remote advertising content stream provider to stream superimposed advertising content onto said real-time game image until said processing means detects that said bitmap image is no longer visible, and thereon cancel said stream and superimpose Coca Co1a™ product placement advertisement content upon predetermined identified object positions.

FIG. 3 view of a preferred embodiment of the ad placement method in computer games of the present invention, wherein and intercepting step, instigated by a detecting step of pause in the sequence of the game, executes a masking of the pause screen with a superimposed fullscreen ad, and after a predetermined time reverts back to the natural progression of the game by unmasking said pause screen.

### DETAILED DESCRIPTION OF THE PREFERRED EMBODIEMNTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide means and method for product placement in video games.

The system of the present invention has many technological advantages, among them: Reducing antagonism towards advert funded websites; Reducing errors due to incompatibilities with specific web-browsers and web technologies; Facilitating control over physical attributes of web adverts; and Facilitating filtering of the content of web adverts. Additional features and advantages of the invention will become apparent from the following drawings and description.

The term ‘masks’ or ‘masking’ interchangeably refers hereinafter to superimposing a first graphical object with a second graphical object, such that said first is no longer visible. The term ‘Push advertising’ refers hereinafter to all efforts to get the word out to an entire group of potential customers in order to hit the few that many be currently interested in your product or service. Most traditional offline advertising efforts (magazine, billboard, newspaper, tv, classifieds, etc) as well as online banners ads and email broadcasts are considered push marketing.

The term ‘Product Placement’ refers hereinafter to a type of advertising, in which promotional advertisements placed by marketers using real commercial products and services in media, where the presence of a particular brand is the result of an economic exchange. When featuring a product is not part of an economic exchange, it is called a product plug. Product placement appears in plays, film, television series, music videos, video games and books. It became more common starting in the 1980s, but can be traced back to at least 1949. Product placement occurs with the inclusion of a brand's logo in shot, or a favorable mention or appearance of a product in shot. This is done without disclosure, and under the premise that it is a natural part of the work. Most major movie releases today contain product placements. The most common form is movie and television placements and more recently computer and video games. Recently, websites have experimented with in-site product placement as a revenue model.

The term ‘overlay’ refers hereinafter to superimposing an overlay layer upon a video content layer thereby creating a visual impression, by means of a synchronized photomontage effect, that objects within the overlay layer are integrated in the content layer. Moreover, the overlay layer may mask objects within the content layer thereby enabling product placement superimposed upon a content layer.

The term ‘object tracking’ is the critical task in many computer vision applications such as surveillance, perceptual user interfaces, augmented reality, smart rooms, object-based video compression, and driver assistance.

The term ‘Augmented reality (AR)’ is a field of computer research which deals with the combination of real-world and computer-generated data. At present, most AR research is concerned with the use of live video imagery which is digitally processed and “augmented” by the addition of computer-generated graphics. Advanced research includes the use of motion-tracking data, fiducial marker recognition using machine vision, and the construction of controlled environments containing any number of sensors and actuators.

The term ‘Advertiser’ refers hereinafter to any legally accountable body that wishes to advertise itself in conjunction with playing of web based video content. An advertiser may be an advert agency, a branding company and ad junction or a combination thereof.

The term ‘Advert’ refers hereinafter to traditional adverts or branding adverts, either in conventional web advert form selected from a group consisting of: banners, text links, and flash, or by advanced product placement enabled by visually analysing the content, tagging it and overlaying it with product placement.

The term ‘Online Overlay Generation’ refers hereinafter to a self-service automated overlay generation system that automates the generation of objects including images, banners, text and links to be incorporated within an overlay layer. Said objects may be utilized to mask or swap objects within the content layer. For example a commercial bottle, or the label thereof, may be superimposed onto a similar object in the content layer.

The term ‘placement zone’ refers to a space, void or surface in at least one frame or caption of a computer game that may be superimposed by an element contained within an overlay layer, said element selected from a group consisting of: a logo, a brand, an image, a product image, a moto, a text, a link, or a combination thereof.

The term ‘superimposed data’ (SID), refers hereinafter to members selected from a group consisting of: still images, films, augmented reality, illustrations, highlights, script, animation, hologram, hyperlink, or a combination thereof.

The term ‘bitmap’ or ‘pixmap’ refers hereinafter to a spatially mapped array of pixels.

The term ‘bitmap time synchronizing’ refers to a method for synchronizing an overlay layer with a content layer, wherein the overlay layer and the content layer are streamed to the viewer's computing means. Both streams remain suspended while the overlay layer is split into an array of bitmap frames. The computer game is then played and once a predetermined frame of the content layer is reached said bitmap frames are superimposed upon said content layer. For example if the overlay layer contains an object that is to be display from timeline 60 sec to timeline 65 sec, on a video running at 25 frames per second, then the split overlay layer will contain 625 bitmap frames to be superimposed onto the overlay layer.

The term ‘cue point event synchronization’ refers to a method for synchronizing an overlay layer with a content layer, wherein the overlay layer and the content layer are streamed to the viewer's computing means. Both streams remain suspend while the overlay layer is split into an array of bitmap frames. The compute game is then played and once a predetermined time has elapsed of the content layer is reached said bitmap frames are superimposed upon said content layer.

The term ‘sync monitor’ refers hereinafter to a means for monitoring computer game events selected from a group consisting of: buffering, stopping play, pausing play or a combination thereof, and matching the sequence of overplayed bitmap frames to said events.

The term ‘object’ refers hereinafter to any visual depiction of actual objects, backgrounds, voids or spaces, contained within a video, or a combination thereof.

The term ‘emulation layer’ refers hereinafter to mirror the layout of the video game output, or parts thereof, such that actions performed by the user via conventional user interface, or events in the progression of the video game, may be monitored or captured. Monitoring or capturing is either performed continually, or in intervals determined by data retrieved from human or automatic pre-analysis of the scenarios of the game output.

The term ‘stream’ refers hereinafter to a method of broadcasting media to a viewer from a distant point, the means of broadcasting may include radio wave broadcasting, web based broadcast, satellite broadcast, landline broadcast, cable broadcast, or a combination thereof. The term ‘wrapper’ refers hereinafter to a data structure that accompanies resources for the purposes of improving convenience, compatibility, or security. Said wrapper “wraps around” other data, so that the contained elements are compatible, and security enabled for communication, with alternate systems. Hence communication between alternate systems is enabled.

The term ‘computer game’ refers hereinafter to electronic games having visual characteristics selected from a group consisting of online games, downloaded games, multiple player games, peer games, network based games, remote server based games, locally based games, game streams, or a combination thereof.

The term ‘Multi-Touch’ refers hereinafter to a set of interaction techniques which allow computer users to control graphical applications with several fingers. Multi-touch consists of a touch screen (screen, table, wall, etc.) or touchpad, as well as software that recognizes multiple simultaneous touch points, as opposed to the standard touchscreen (e.g. computer touchpad, ATM), which recognizes only one touch point. This effect is achieved through a variety of means, including but not limited to: heat, finger pressure, high capture rate cameras, infrared light, optic capture, tuned electromagnetic induction, ultrasonic receivers, transducer microphones, laser rangefinders, and shadow capture.

The term ‘sampling’ refers hereinafter to periodically capturing a visual segment of the fullscreen video content and subsequently analysing visual aspects of said segment.

The term ‘caption refers hereinafter to a copy of the image displayed on screen at any given moment.

The term ‘event’ refers hereinafter to an audio or visual occurrence identified by scanning a series of captions. The identification of the event is either done offline or online, and may also be automated.

The terms ‘click’ or ‘touch’ refer hereinafter to an indication or selection provided by user interface means. The selection or indication may relate to a particular zone or object within a screen caption, or it may relate to the entirety of said caption.

The term ‘AV caption’ refers hereinafter to captions of audio output, visual output or a combination thereof, generated by a computer game.

The term ‘fullscreen’ refers hereinafter to a visual output that uses the entirety of available screen area, as opposed to windows that fill the screen only partially.

The term ‘legacy ad server’ refers hereinafter to an ad server that contains javascript or iframe tags that are tailored for HTML presentation.

The term ‘user details’ refers hereinafter to user agent and cookies data pertaining to any web based activity that is specific to a particular user, any data provided directly or indirectly by the user, any other demographic data, or a combination thereof

The present invention is especially useful for intelligently inserting ads into the correct slot of dynamic content, such as computer games, without placing strain on processing power. For example consider a game wherein certain virtual buttons or controls appear on particular levels of the game, but not on others. Traditional object tracking means would require continuous tracking of the segment of computer game content in order to detect the appearance of said buttons or controls, and subsequently activate a means for registering input from the user, such as a mouse click. Due to the continuous AV capture and analysis involved in this conventional process, a significant strain is placed on processing power. The present invention provides an alternative method to detecting the appearance of a virtual button or control. Rather than continuously capturing a segment of the output generated by the game, the present invention monitors the mouse actions by detecting a click upon an emulation layer superimposed upon the content. Only once the click is detected is the sampling of the content triggered and subsequently the progression of the game is determined. Thus by removing the need to continuously track objects within the content layer, processing power requirements are reduced.

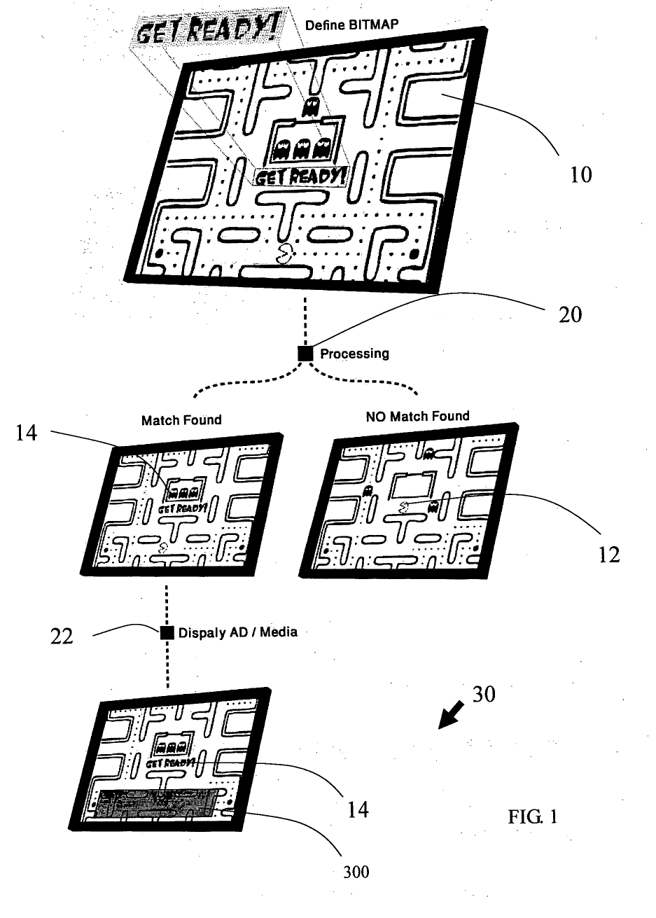

Reference is now made to FIG. 1, illustrating a schematic view of a preferred embodiment of the system and method for precision in-game dynamic advert placement in computer games of the present invention, wherein real-time image 10 is presented to the player on a game playing means, a processing means 20, having access to a screen caption of said real-time image, locates and tracks the appearance of previously identified bitmap image 14 ‘GET READY’, said processing means is networked (not shown) with remote advertising content stream provider 22, instructing said provider to stream superimposed advertising content 300 onto image 10, thus displaying image 30 until said processing means detects that said bitmap image is no longer visible and cancels said superimposed content thereby reverting to image 10.

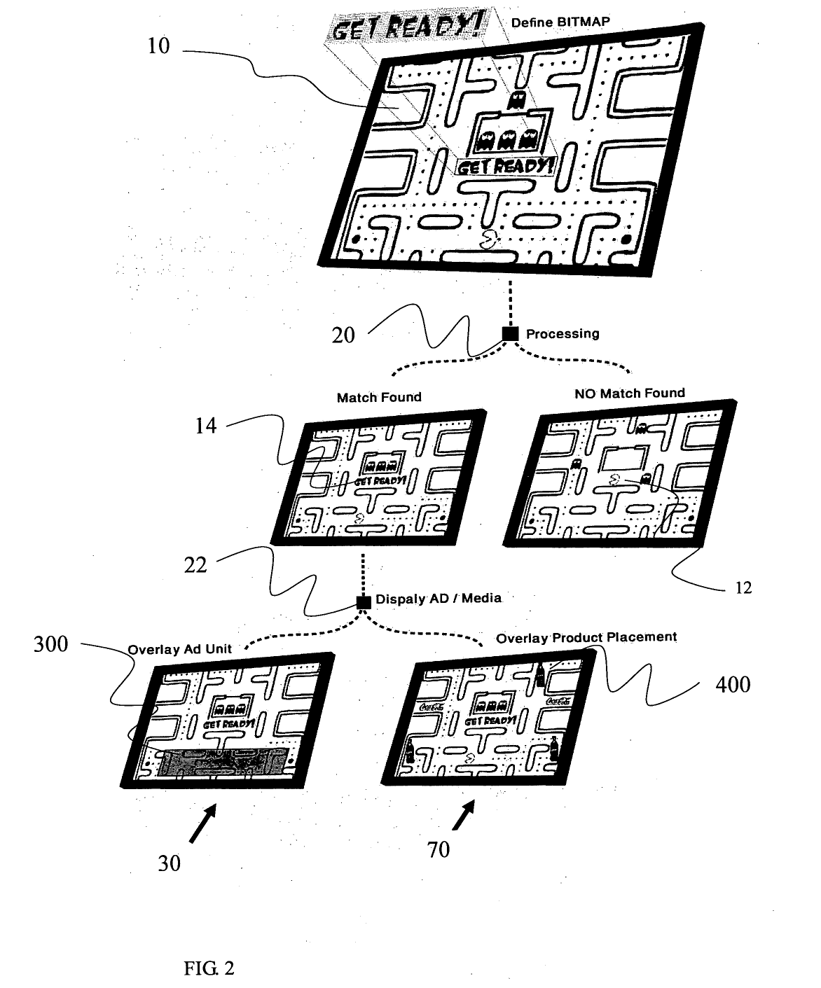

Reference is now made to FIG. 2, illustrating a schematic view of a preferred embodiment of the system and method for precision in-game dynamic advert placement in computer games of the present invention, wherein real-time image 10 is presented to the player on a game playing means, a processing means 20, having access to a screen caption of said real-time image, locates and tracks the appearance of previously identified bitmap image 14 ‘GET READY’, said processing means is networked (not shown) with remote advertising content stream provider 22, instructing said provider to stream superimposed advertising content 300 onto image 10, until said processing means detects that said bitmap image is no longer visible, and thereon cancel said stream and superimposed Coca Co1a™ product placement advertisement content 400 upon predetermined identified object positions.

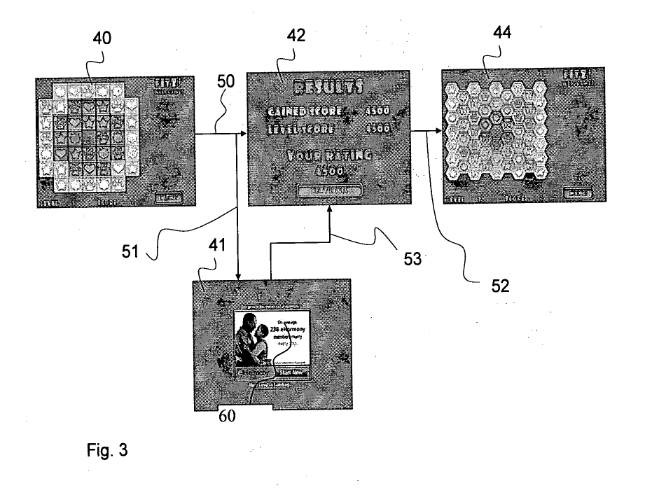

Reference is now made to FIG. 3, illustrating a schematic view of a preferred embodiment of the method for precision in-game dynamic advert placement in computer games of th present invention, wherein intercepting step 51, is instigated by detecting step (not shown) of pause screen 42, intercepting the natural progression 50,52 of the stages of the game through screens 40, 42, 44, and masking screen 42 from the view of the user for a predetermined time, while emulating the look-and-feel of the game and displaying ‘game loading’ indication 60, thereby pacifying the user during the exposure to fullscreen ad 41.

1. A system for precision in-game dynamic advert placement in computer games, comprising:
(a) networked game playing means; having access to,
(b) at least one game, stored in at least one game domain;
(c) means for obtaining at least one real-time AV caption of the output generated by said computer game;
(d) means for identifying objects, AV events, or a combinations thereof, having access to said at least one AV output of said at least one computer game;
(e) means for superimposing at least one remotely stored advertising content onto the entirety of said at least one caption, or onto parts thereof; wrapper means, located at said game domain, wrapping said game; and,
(f) means for customizing ads to be downloaded by said wrapper to the location of said game playing means;
wherein said ad customizing means, synchronizes the audio-visual display generated by said game with said superimposed advertising content, and controls, within a precession of milliseconds, the insertion and removal of said advertising content, thereby offering a distortion-free viewing experience

2. The ad placement system according to claim 1, additionally comprising emulation means that superimposes at least one invisible emulation layer, which is click, touch or event enabled, on top of said visual output generated by said computer game; wherein said superimposed emulation layer, mediated by said ad customizing means, communicates instructions to said game playing means, said means for superimposing ad content, or a combination thereof, such that insertion and removal of ad content corresponds to the dynamic real-time progression of said game, as well as real time user actions.

3. The system according to claim 1, additionally comprising object tracking means adapted for locating and tracking said identified objects or events.

4. The system according to claim 1, wherein said game is stored locally, remotely, or a combination thereof.

5. The system according to claim 1, wherein the format of said advertising content is selected from a group consisting of flash, animation, Html, script, images, video, hyperlink, music, vocals, or a combination thereof.

6. The system according to claim 1, wherein the physical characteristics of said advertising content is selected from a group consisting of transparent, semi-transparent, opaque, still, animation, or a combination thereof.

7. The system according to claim 1, wherein said advertising content is selected from a group consisting of promotions, vouchers, rebates, virtual prizes, physical prizes, or a combination thereof.

8. The system according to claim 1, additionally comprising an audio processing and analysis means.

9. The system according to claim 1, wherein said game is compiled in a format selected from a group consisting of flash, video stream, shockwave, java applet, C++, C# Visual Basic, Java, ActiveX, Adobe AIR Application, Widget, Gadget, Microsoft Silverlight, Dot Net framework based language, or a combination thereof.

10. The system according to claim 1, additionally comprising a remote database for logging said instructions.

11. The system according to claim 1, additionally comprising means for toggling between visible and invisible modes of said superimposed advertising content.

12. The system according to claim 1, additionally comprising means for storing data obtained from said object identification means.

13. The system according to claim 1, additionally comprising a real-time synchronization means for interrupting or cancelling said stream of superimposed advertising content in response to data obtained from said object tracking means.

14. The system according to claim 1, additionally comprising a display means interconnected to said playing means.

15. The system according to claim 2, wherein said object identification means is selected from a group consisting of a human observer, and automated observer, or a combination thereof.

16. The system according to claim 1, wherein said objects are selected from a group consisting of backgrounds, players, icons, items, script, images, videos, animation, or a combination thereof.

17. The system according to claim 1, wherein said networked connection is selected from a group consisting of wired, wireless, or a combination thereof.

18. The system according to claim 17, wherein said wireless communication means is selected from a group consisting of: WIFI, WIMAX, cellular, satellite, RFID, or a combination thereof.

19. The system according to claim 1, wherein said game playing means additionally comprises a GPS location identification means.

20. The system according to claim 1, wherein said game playing means additionally comprises a unique identification code.

21. The system according to claim 1, additionally comprising image analysing means for analysing the visual characteristics of said objects and the area surrounding them.

22. The system according to claim 1, additionally comprising object recognition processing means.

23. The system according to claim 1, wherein said emulation layer additionally comprises predefined trigger-zones wherein user input, AV events, or a combination thereof trigger instructions to said ad superimposing means, said game playing means or a combination thereof.

24. The system according to claim 1, additionally comprising event or user action activated sampling means.

25. A method for precision in-game dynamic advert placement in computer games, comprising the steps of:
(a) obtaining a system for precision in-game dynamic advert placement in computer games, comprising:
i) networked game playing means; having access to,
(1) at least one game, stored in at least one game domain;
ii) means for obtaining at least one real-time AV caption of the output generated by said computer game;
iii) means for identifying objects, AV events, or a combinations thereof, having access to said at least one AV output of said at least one computer game;
iv) means for superimposing at least one remotely stored advertising content onto the entirety of said at least one caption, or onto parts thereof; wrapper means, located at said game domain, wrapping said game; and,
v) means for customizing ads to be downloaded by said wrapper to the location of said game playing means;
vi)
(b) identifying at least one object, zone, or event within said computer game output by said object identification means;
(c) initiating said game by user;
(d) downloading said wrapper means to the location of said game playing means;
(e) initiating said wrapper means;
(f) downloading said ad customizing means to location of said game playing means;
(g) initiating said ad customizing means;
(h) requesting a real time AV Caption by said ad customizing means from said wrapper means;
(i) validating the security protocol of said customizing means by said wrapper means;
(j) capturing a real time AV caption by the wrapper;
(k) delivering said caption to said ad customizing means
(l) searching said audio-visual caption for said identified objects or events;
(m) locating said identified at least one object, zone, or event in said visual caption;
(n) downloading said remotely stored advertising content;
(o) synchronizing the insertion and removal of said advertising content with audio visual content generated by said game;
(p) superimposing, within millisecond precision, said advertising content upon said identified at least one object, zone, or event in said real-time bitmap frame;
(q) repeating said capturing, searching, locating, synchronizing and superimposing steps at intervals until said objects or events are no longer detected, or until a predetermined time has lapsed; and,
(r) displaying said game generated bitmap frame without intervention of said superimposed ad content;
wherein said step of synchronizing, within a precession of milliseconds, the insertion and removal of said advertising content, enables distortion-free in-game dynamic advertising.

26. The method according to claim 25, wherein said capturing step comprises sampling a limited segment of the full visual frame.

27. The method according to claim 26 wherein said limited segment is selected from a group consisting of: virtual buttons, virtual items, virtual objects, text, icons, animation, or a combination thereof.

28. The method according to claim 25, additionally comprising a step of tracking said at least one objet, zone, or event.

29. The method according to claim 26, wherein the instigation and duration of said tracking step is determined by user actions or computer game events captured by said emulation layer.

30. The method according to claim 26, wherein said tracking step is executed by sampling a segment of said content video frame.

31. The method according to claim 25, additionally comprising a step of interrupting said streaming step, on object movement data obtained from said step of tracking said objects.

32. The method according to claim 31, wherein said interrupting step is selected from a group consisting of cancelling, fading out, shifting transparency rate, or a combination thereof.

33. The method according to claim 31, wherein said interrupting step is instigated by an additional step of interfacing with the user of said game playing means.

34. The method according to claim 33, wherein said interfacing step is selected from a group consisting of selecting game options, performing game actions, or a combination thereof.

35. The method according to claim 25, additionally comprising a step of detecting, by means of said object tracking means, intervals in the progress, sequence or motion of said game, and subsequently superimposing said advertising content onto said identified objects.

36. The method according to claim 35, additionally comprising the steps of detecting a pause screen within the natural sequence of the play, intercepting the visual progression of the game and superimposing, for a predetermined duration, full screen or partial screen ads onto the display generated by said game, such that said ads mask standard game interval messages selected from a group consisting of pause screens, click to continue screens, user input screens, game over screens, or a combination thereof.

37. The method according to claim 36 wherein said ads are full screen and are set on a background that emulates the look-and-feel of the standard game screens.

38. The method according to claim 36, comprising the additional step of pacifying the user during the exposure to the ad by display a game loading indication.

39. The method according to claim 25, additionally comprising a step of downloading said game to said networked game playing means.

40. The method according to claim 25, additionally comprising object recognition processing means, said method additionally comprising a step of processing said AV caption and retrieving object recognition data.

41. The method according to claim 25, additionally comprising a step of selecting and contextually matching said selected advertisement content with said object recognition data.

42. The method according to claim 25, additionally comprising a step of toggling between visible and invisible modes of said superimposed advertising content.

43. The method according to claim 25, additionally comprising a step of masking said identified objects by means of superimposing said advertising content onto said identified object, such that said objects are no longer visible.

44. The method according to claim 25, additionally comprising a step of interrupting or cancelling said stream of superimposed advertising content in response to data obtained from said object tracking means.

45. The method according to claim 25, additionally comprising an audio analysis means, said method additionally comprising a step of determining the sequence of superimposing said advertising content according to said analysis.

46. The method according to claim 25, wherein the display of said computer game output and said superimposed layers is in fullscreen.

47. The method according to claim 25, wherein setting the frequency of said intervals is determined in a manner selected from a group consisting of: predetermined, determined by user input or computer game events captured by said emulation layer, or a combination thereof.

48. A method for precision in-game dynamic advert placement in computer games, comprising the steps of:
(a) obtaining an ad placement system for superimposing advertising content onto computer games, comprising:
i) networked game playing means; having access to,
ii) at least one game, stored in at least one game domain;
iii) means for obtaining at least one real-time AV caption of the output generated by said computer game;
iv) means for identifying objects, AV events, or a combinations thereof, having access to said at least one AV output of said at least one computer game;
v) means for superimposing at least one remotely stored advertising content onto the entirety of said at least one caption, or onto parts thereof;
vi) wrapper means, located at said game domain, wrapping said game;
vii) means for customizing ads to be downloaded by said wrapper to the location of said game playing means; and
viii) emulation layer superimposing means that superimposes an invisible click, touch or game event enabled control layer on top of said visual output from said computer game.
(b) identifying objects within said computer game output by said object identification means;
(c) generating said emulation layer containing said identified objects;
(d) initiating said game by user;
(e) downloading said wrapper means to the location of said game playing means;
(f) initiating said wrapper means;
(g) downloading said ad customizing means to the location of said game playing means;
(h) initiating said ad customizing means;
(i) validating the security protocol of said ad customizing means by said wrapper means;
(j) superimposing said invisible emulation layer onto output generated by said computer game;
(k) capturing a caption of said emulation layer;
(l) searching said caption for said identified at least one object, action or event;
(m) locating said identified at least one object, zone, or event in said caption;
(n) downloading said remotely stored advertising content;
(o) synchronizing the insertion and removal of said advertising content with audio visual content generated by said game;
(p) superimposing, within millisecond precision, said advertising content;
(q) repeating said capturing, searching, locating, synchronizing and superimposing steps at intervals until said objects or events are no longer detected, or until a predetermined time has lapsed; and
(r) displaying said game generated bitmap frame without intervention of said superimposed ad content;
wherein superimposing said emulation layer upon said game generated outpout, and capturing events and action upon said layer, enables the insertion and removal of ad content that corresponds to the dynamic real-time progression of said game, as well as real time user actions.

49. The method according to claim 48, wherein said at least one action, or event are selected from a group consisting of swipe, touch, multi-touch, click, mouse over, mouse up, mouse down, drag and drop, real time audio-visual events or a combination thereof.

50. The method according to claim 48, wherein said capturing step comprises sampling a limited segment of the full video frame.

51. The method according to claim 50 wherein said limited segment is selected from a group consisting of: virtual buttons, virtual items, virtual objects, text, icons, animation, or a combination thereof.

52. The method according to claim 48, additionally comprising a step of tracking said objects.

53. The method according to claim 52, wherein the instigation and duration of said tracking objects step is determined by user actions, predetermined time intervals, or computer game events captured by said emulation layer.

54. The method according to claim 52, wherein said tracking step is executed by sampling a segment of the content video frame.

55. The method according to claim 48, additionally comprising a step of interrupting said streaming step on object movement data obtained from said step of tracking said objects.

56. The method according to claim 55, wherein said interrupting step is selected from a group consisting of cancelling, fading out, shifting transparency rate, or a combination thereof.

57. The method according to claim 55, wherein said interrupting step is instigated by an additional step of interfacing with the user of said game playing means.

58. The method according to claim 57, wherein said interfacing step is selected from a group consisting of selecting game options, performing game actions, or a combination thereof.

59. The method according to claim 57, wherein said system for superimposing advertising content onto computer games additionally comprising object tracking, additionally comprising a step of detecting, by means of said object tracking means, intervals in the progress, sequence or motion of said game, and subsequently superimposing said advertising content onto said identified objects.

60. The method according to claim 48, additionally comprising a step of downloading said game to said networked game playing means.

61. The method according to claim 48, additionally comprising object recognition processing means, said method additionally comprising a step of processing said AV caption and retrieving object recognition data.

62. The method according to claim 48, additionally comprising a step of selecting and contextually matching said selected advertisement content with said object recognition data.

63. The method according to claim 48, additionally comprising a step of toggling between visible and invisible modes of said superimposed advertising content.

64. The method according to claim 48, additionally comprising a step of masking said identified objects by means of superimposing said advertising content onto said identified object, such that said objects are no longer visible.

65. The method according to claim 48, additionally comprising a step of interrupting or cancelling said stream of superimposed advertising content in response to data obtained from said object tracking means.

66. The method according to claim 48, additionally comprising an audio analysis means, said method additionally comprising a step of determining the sequence of superimposing said advertising content according to said analysis.

67. The method according to claim 48, wherein the display of said computer game output and said superimposed layers is in fullscreen.

68. The method according to claim 48, wherein setting the frequency of said intervals is determined in a manner selected from a group consisting of: predetermined, determined by user input or computer game events captured by said emulation layer, or a combination thereof.

69. The method according to claim 48, wherein said capturing and searching steps are triggered by user actions detected upon said emulation layer, thereby minimizing the time that strain is placed upon computer processing power.

70. The method according to claim 48, additionally comprising the steps of detecting a pause screen with the natural sequence of the play, intercepting the visual progression of the game and superimposing, for a predetermined duration, full screen or partial screen ads onto the game output, such that said ads mask standard game interval messages selected from a group consisting of pause screens, click to continue screens, user input screens, game over screens, or a combination thereof.

71. The method according to claim 48 wherein said ads are full screen and are set on a background that emulates the look-and-feel of the standard game screens.

72. The method according to claim 48, comprising the additional step of pacifying the user during the exposure to the ad by display a game loading indication.

73. The method according to claim 48, wherein said emulation layer masks clickable objects, such that the user cannot click on them for a predetermined time.

74. The system according to claim 1, wherein both said computer game output is in fullscreen.

75. The method according to claim 48 additionally comprising a step of determining the remote advertising content to be downloaded in step downloading step according to established user data.

76. The method according to claim 75 wherein said data is selected from a group consisting of demographics data, predetermined groups, registered groups, user input, address, computer playing means, computer playing means system, web browser search log, or a combination thereof.

77. The system according to claim 1, wherein ad content from legacy ad servers, solicited according to user-specific details, is adapted in real-time for presentation in flash based web applications, said system additionally comprising:
(a) means for soliciting said legacy ad server content,
(b) means for intercepting the presentation of said content;
(c) means for analysing said content;
(d) means for generating an simulation of said content; and,
(e) means for presenting said simulation instead of said content.

78. An ad placement system, wherein ad content from legacy ad servers, solicited according to user-specific details, is adapted in real-time for presentation in flash based web applications, said system comprising:
(a) means for soliciting said legacy ad server content,
(b) means for intercepting the presentation of said content;
(c) means for analysing said content;
(d) means for generating an simulation of said content; and,
(e) means for presenting said simulation instead of said content.

79. The method according to claim 48 additionally comprising the steps of:
(a) obtaining an ad placement system, comprising:
i) means for soliciting legacy ad server content,
ii) means for intercepting the presentation of said content;
iii) means for analysing said content;
iv) means for generating an simulation of said content; and,
v) means for presenting said simulation instead of said content.
(b) soliciting at least one legacy ad server content, while identifying to said ad server with user details of the user;
(c) sending content by said ad server to said user;
(d) intercepting the presentation of said ad content to said user;
(e) analysing said content;
(f) generating an simulation of said content; and
(g) presenting said simulation instead of said content.

80. A method for ad placement, comprising the steps of:
(a) obtaining an ad placement system, comprising:
i) means for soliciting legacy ad server content,
ii) means for intercepting the presentation of said content;
iii) means for analysing said content;
iv) means for generating an simulation of said content; and,
v) means for presenting said simulation instead of said content.
(b) soliciting at least one legacy ad server content, while identifying to said ad server with user details of the user;
(c) sending content by said ad server to said user;
(d) intercepting the presentation of said ad content to said user;
(e) analysing said content;
(f) generating an simulation of said content; and
(g) presenting said simulation instead of said content;
wherein legacy ad content that was tailored for html presentation is presented in flash compatible format.

81. The system according to claim 1, wherein said synchronization is bitmap time synchronizing.

82. The system according to claim 2 wherein said objects are selected from a group consisting of backgrounds, players, icons, items, script, images, videos, animation, or a combination thereof.

83. The system according to claim 2, wherein both said computer game output is in fullscreen.

84. The method according to claim 25 additionally comprising a step of determining the remote advertising content to be downloaded in step downloading step according to established user data.

85. The method according to claim 25 additionally comprising the steps of:
a. obtaining an ad placement system, comprising:
i. means for soliciting legacy ad server content,
ii. means for intercepting the presentation of said content;
iii. means for analysing said content;
iv. means for generating an simulation of said content; and,
v. means for presenting said simulation instead of said content.
b. soliciting at least one legacy ad server content, while identifying to said ad server with user details of the user;
c. sending content by said ad server to said user;
d. intercepting the presentation of said ad content to said user;
e. analysing said content;
f. generating an simulation of said content; and
g. presenting said simulation instead of said content.
